(19) United States
(12) Patent Application Publication
(10) Pub. No.: US 2026/0044411 A1
(43) Pub. Date: Feb. 12, 2026

(54) STORAGE DEVICE, MEMORY CONTROLLER AND METHOD OF OPERATING MEMORY CONTROLLER

(71) Applicant: SK hynix Inc., Icheon-si (KR)

(72) Inventor: Du Hyun KIM, Icheon-si (KR)

(21) Appl. No.: 19/206,863

(22) Filed: May 13, 2025

(30) Foreign Application Priority Data
Aug. 8, 2024 (KR) 10-2024-0106007

(51) Int. Cl. G06F 11/10; G06F 13/16

(52) U.S. Cl. CPC G06F 11/1016; G06F 11/1068; G06F 13/1673

(57) ABSTRACT

Provided herein may be a storage device. The storage device may include a command manager for receiving a RMW request, from a host device, to perform read, modify, and write operations on target data stored in a memory device and transmitting RMW read and write commands included in the RMW request to the memory device, a history buffer for storing RMW write data, a history buffer manager for generating first modified data corresponding to the target data based on the RMW write data, an error correction decoder for performing an error correction decoding operation for the target data from the memory device, and a read data manager for receiving the target data corresponding to the RMW read command from the memory device and transferring the target data to the history buffer and the error correction decoder.

### CROSS-REFERENCE TO RELATED APPLICATION

The present application claims the benefit of priority under 35 U.S. C. § 119(a) to Korean patent application number 10-2024-0106007 filed on Aug. 8, 2024, in the Korean Intellectual Property Office, the entire disclosure of which is incorporated herein by reference.

### BACKGROUND

### 1. Technical Field

Various embodiments of the present disclosure generally relate to a storage device, and more particularly to a storage device, a memory controller, and a method of operating the memory controller.

### 2. Related Art

A storage device is a device that stores data under the control of a host device, such as a computer or a smartphone. The storage device may include a memory device in which data is stored and a memory controller, which controls the memory device. Memory devices may be classified into volatile memory devices and nonvolatile memory devices. Volatile memory devices are memory devices in which data is stored only when power is supplied and in which stored data is lost when the supply of power is interrupted. Nonvolatile memory devices are memory devices in which stored data is retained even when the supply of power is interrupted.

The controller uses an error correction code in order to protect data read from the memory device. The probability of bit flip occurring in data read from a Dynamic Random Access Memory (DRAM) may be very low. Performing an error correction decoding operation for all read data causes a delay, which may reduce the performance of the memory device.

### SUMMARY

Various embodiments of the present disclosure are directed to a storage device that minimizes delay by skipping an error correction decoding operation for read data during a read-modify-write operation and to a method of performing the read-modify-write operation.

An embodiment of the present disclosure may provide for a memory controller. The memory controller may include a command manager configured to receive a read-modify-write (RMW) request, from a host device, to perform read, modify, and write operations on target data stored in a memory device and configured to transmit an RMW read command and an RMW write command included in the RMW request to the memory device, a history buffer configured to store RMW write data corresponding to the RMW write command, a history buffer manager configured to generate first modified data corresponding to the target data based on the RMW write data, an error correction decoder configured to perform an error correction decoding operation for the target data received from the memory device based on an error correction code, and a read data manager configured to receive the target data corresponding to the RMW read command from the memory device and to transfer the target data to the history buffer and the error correction decoder, and the history buffer manager may generate the first modified data before the error correction decoding operation is performed for the target data.

An embodiment of the present disclosure may provide for a method of operating a memory controller. The method may include receiving a read-modify-write (RMW) request, from a host device, to perform read, modify, and rewrite operations on target data stored in a memory device, transmitting an RMW read command included in the RMW request to the memory device, receiving the target data corresponding to the RMW read command from the memory device, generating first modified data based on the target data and RMW write data corresponding to an RMW write command included in the RMW request before performing an error correction decoding operation for the target data, and transmitting the RMW write command and the first modified data to the memory device.

An embodiment of the present disclosure may provide for a storage device. The storage device may include a memory device configured to store data and a memory controller configured to control operations of the memory device. The memory controller may include a command manager configured to receive a read-modify-write (RMW) request, from a host device, to perform read, modify, and rewrite operations on target data stored in the memory device and configured to transmit an RMW read command included in the RMW request to the memory device, a history buffer configured to store RMW write data corresponding to an RMW write command included in the RMW request, and a history buffer manager configured to generate first modified data corresponding to the RMW write command based on the RMW write data and the target data, and the command manager may transmit the RMW write command and the first modified data to the memory device without performing an error correction decoding operation for the target data.

### BRIEF DESCRIPTION OF THE DRAWINGS

FIG. 1 is a diagram illustrating a storage device according to an embodiment of the present disclosure.

FIG. 2 is a diagram illustrating an RMW operation that minimizes delay resulting from an error correction decoding operation for target data according to an embodiment of the present disclosure.

FIG. 3 is a diagram illustrating an RMW operation for rewriting modified data when an error bit is detected in target data according to an embodiment of the present disclosure.

FIG. 4 is a diagram illustrating commands and data that are transferred when an RMW operation is performed according to an embodiment of the present disclosure.

FIG. 5 is a diagram illustrating data packets stored in a history buffer according to an embodiment of the present disclosure.

FIG. 6 is a flowchart illustrating a method of performing an RMW operation according to an embodiment of the present disclosure.

### DETAILED DESCRIPTION

Specific structural or functional descriptions in the embodiments of the present disclosure introduced in this specification or application are provided as examples to describe embodiments according to the concepts of the present disclosure. The embodiments according to the concepts of the present disclosure may be practiced in various forms, and should not be construed as being limited to the embodiments described in the specification or application.

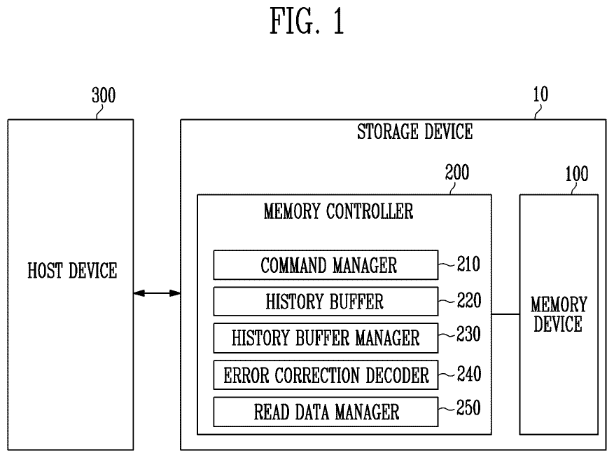

FIG. 1 is a diagram illustrating a storage device according to an embodiment of the present disclosure.

Referring to FIG. 1, a storage device 10 may include a memory device 100 and a memory controller 200, which controls the operation of the memory device 100. The storage device 10 may be a device that stores data under the control of a host device 300, such as a mobile phone, a smartphone, an MP3 player, a laptop computer, a desktop computer, a game console, a television (TV), a tablet PC, or an in-vehicle infotainment system.

The storage device 10 may be manufactured as any one of various types of storage devices depending on a scheme for communication with the host device 300. For example, the storage device 10 may be configured as any one of various types of storage devices, such as a compute express link (CXL) storage device, a multimedia card in the form of a solid-state drive (SSD), a multimedia card (MMC), an embedded MMC (eMMC), a reduced-size MMC (RS-MMC), or a micro-MMC, a secure digital card in the form of SD, mini-SD, or micro-SD, a universal serial bus (USB) storage device, a universal flash storage (UFS) device, a storage device in the form of a peripheral component interconnection (PCI) card, a storage device in the form of a PCI express (PCI-E) card, a compact flash (CF) card, a smart media card, and a memory stick.

The memory device 100 may store data. The memory device 100 operates in response to the control of the memory controller 200. The memory device 100 may include a plurality of memory blocks. A memory block may include a plurality of memory cells that store data. The memory cells connected to the same word line, among the plurality of memory cells, may be defined as a single physical page.

In an embodiment, a memory device 100 may take many alternative forms, such as a random access memory (RAM), a nonvolatile memory (NVM), a double data rate synchronous dynamic random access memory (DDR SDRAM), a low power double data rate fourth generation (LPDDR4) SDRAM, a graphics double data rate (GDDR) SDRAM, a low power DDR (LPDDR) SDRAM, a Rambus DRAM (RDRAM), a NAND flash memory, a resistive RAM (RRAM), a phase-change memory (PRAM), a magnetoresistive RAM (MRAM), a ferroelectric RAM (FRAM), or a spin transfer torque RAM (STT-RAM).

The memory device 100 may receive a command and an address from the memory controller 200, and may access an area selected by the address among storage areas. That is, the memory device 100 may perform an operation indicated by the command on the area selected by the address. For example, the memory device 100 may perform a write operation (program operation), a read operation, and an erase operation. During a program operation, the memory device 100 may program data to the area selected by the address. During a read operation, the memory device 100 may read data stored in the area selected by the address. During an erase operation, the memory device 100 may erase data stored in the area selected by the address.

The memory controller 200 controls the overall operation of the storage device 10. The memory controller 200 may receive data and a logical address from the host device 300 and translate the logical address into a physical address indicating the address of the memory cells included in the memory device 100 in which the data is to be stored. In an embodiment of the present disclosure, the memory controller 200 may be a CXL controller included in a CXL storage device.

The memory controller 200 may control the memory device 100 to perform a program operation, a read operation, an erase operation, or the like in response to a request from the host device 300. During a program operation, the memory controller 200 may provide a write command, a physical address, and data to the memory device 100. During a read operation, the memory controller 200 may provide a read command and a physical address to the memory device 100. During an erase operation, the memory controller 200 may provide an erase command and a physical address to the memory device 100.

In an embodiment of the present disclosure, the memory controller 200 may receive an RMW request to perform read, modify, and write operations on target data from the host device 300. In response to the RMW request, the target data read from the memory device 100 is modified by the memory controller 200 and stored in the memory device 100, rather than being provided to the host device 300.

In an embodiment of the present disclosure, the memory controller 200 may include a command manager 210, a history buffer 220, a history buffer manager 230, an error correction decoder 240, and a read data manager 250. The memory controller 200 may read the target data from the memory device 100, modify the same, and rewrite the modified target data to the memory device 100 in response to the RMW request received from the host device 300.

The command manager 210 may receive requests from the host device 300. The requests may include commands and information related to the commands. In an embodiment of the present disclosure, the command manager 210 may receive an RMW request. The RMW request may include an RMW read command, an RMW write command, RMW write data, an RMW flag, a data mask, and the like. The RMW flag is information indicating that the request received from a host is an RMW request. The data mask may indicate a portion corresponding to the RMW read command that is modified by the RMW write command in the target data read from the memory device 100.

The command manager 210 may transmit a read command to the memory device 100 in response to reception of the read command from the host. The command manager 210 may transmit a write command and write data to the memory device 100. The command manager 210 may sequentially transmit commands that are ready to be transmitted to the memory device 100.

The history buffer 220 may store data packets corresponding to write commands. In an embodiment of the present disclosure, the history buffer 220 stores data packets corresponding to normal write commands and RMW write commands. The data packet may include RMW write data, a data mask, an RMW flag, and the like.

The history buffer manager 230 may manage the data stored in the history buffer 220. The history buffer manager 230 may generate first modified data based on the target data received from the read data manager 250 and the RMW write data stored in the history buffer 220. The history buffer manager 230 may generate a ready bit indicating generation of the first modified data. The history buffer 220 may store RMW write data including the ready bit.

The error correction decoder 240 may perform an error correction decoding operation for the read data received from the memory device 100 based on an error correction code. The error correction decoder 240 may generate corrected data in response to detection of an error bit. The error correction decoder 240 may notify the history buffer manager 230 that no error bit occurs in response to detection of an error bit in the target data read from the memory device 100 or may transfer the corrected data to the history buffer manager 230 in response to detection of an error bit in the target data read from the memory device 100.

When no error bit is detected as the result of performing the error correction decoding operation, the history buffer manager 230 may delete the data packet related to the RMW write command from the history buffer. In response to detection of an error bit in the target data, the history buffer manager 230 may generate second modified data based on the corrected data and the RMW write data.

The error correction decoder 240 may transfer the result of error correction decoding for the target data to the history buffer manager 230. Based on the result of the error correction decoding, the history buffer manager 230 may set the bit value of a decoding bit indicating whether an error correction operation is performed. The history buffer 220 may store RMW write data including the decoding bit.

The read data manager 250 may receive read data from the memory device 100. The read data manager 250 may receive the read data corresponding to a read command transmitted by the command manager 210.

In an embodiment of the present disclosure, the read data manager 250 may transfer the target data corresponding to the RMW read command to both the history buffer manager 230 and the error correction decoder 240 in response to transmission of the RMW read command to the memory device 100. The history buffer manager 230 may use the target data to generate first modified data, and the error correction decoder 240 may generate corrected target data depending on whether an error bit is detected in the target data.

In an embodiment of the present disclosure, the error correction decoding operation for the target data may be skipped in order to prevent a delay in an operation of the memory device 100. The history buffer manager 230 may generate the first modified data before the error correction decoding operation is performed for the target data, and the command manager 210 may transmit the RMW write command and the first modified data to the memory device 100. The memory device 100 may perform a write operation based on the RMW write command and the first modified data. However, because there is a possibility that an error bit is detected in the target data, the error correction decoding operation may be performed separately from generation of the first modified data. When an error bit is detected as the result of the error correction decoding operation, the history buffer manager 230 may generate a second modified data based on the error correction decoding operation, and the command manager 210 may transmit the generated second modified data and the RMW write command to the memory device 100. In order to speed up processing of the RMW command, the error correction decoding operation may be skipped in an embodiment of the present disclosure. Because there is a possibility that an error bit is included in the target data, the history buffer manager 230 may retain the RMW write data in the history buffer until the error correction operation result is passed.

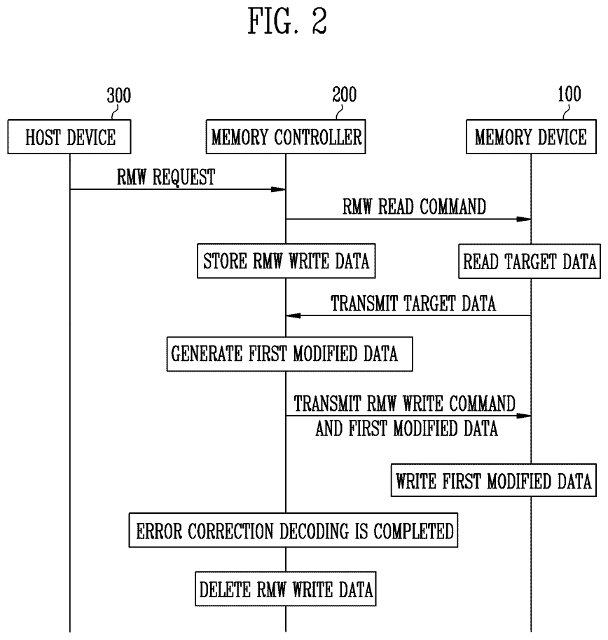

FIG. 2 is a diagram illustrating an RMW operation that minimizes delay resulting from an error correction decoding operation for target data according to an embodiment of the present disclosure.

FIG. 2 refers to an embodiment in which no error bit is detected in target data corresponding to an RMW request. An RMW request may include an RMW read command, an RMW write command, an RMW flag, a data mask, and the like. A command manager 210 may check whether a request received from a host device 300 is an RMW request based on an RMW flag. The command manager 210 may transfer a RMW read command received from a host device 300 to a memory device 100. The memory device 100 may read the target data corresponding to an RMW read command. The read target data may be transmitted to a memory controller 200.

The memory controller 200 may store write data corresponding to a RMW write command in the history buffer 220. The rest of the RMW request, excluding the RMW read command, may be stored in the history buffer 220. A data packet, including RMW write data corresponding to the RMW write command, an RMW flag, a data mask, and the like, may be stored in the history buffer 220.

A read data manager 250 may determine whether the data received from the memory device 100 is the target data corresponding to the RMW read command. In response to receiving the target data corresponding to the RMW read command from the memory device 100, the read data manager 250 may transfer the target data to a history buffer manager 230 and an error correction decoder 240. In response to receiving normal read data corresponding to normal read command, the read data manager 250 may transfer the normal read data received from the memory device 100 to only the error correction decoder 240.

The history buffer manager 230 may generate first modified data based on the target data and the RMW write data stored in the history buffer 220. The history buffer manager 230 may determine the portion to be modified in the target data using a data mask. The history buffer manager 230 may generate the first modified data by applying the RMW write data to a portion in the target data to be modified.

The history buffer manager 230 may set the value of a ready bit, which indicates that an RMW write command waits for transmission, to a first value in response to generation of the first modified data. The first modified data may be generated before an error correction decoding operation is performed for the target data. The history buffer manager 230 may set the value of a decoding bit, indicating whether the error correction decoding operation is completed, in response to generation of the first modified data to the first value.

The command manager 210 may transmit the RMW write command and the first modified data to the memory device 100. The value of the ready bit may be changed from the first value to a second value in response to transmission of the first modified data and the RMW write command to the memory device 100. The memory device 100 may perform the operation of storing the first modified data based on the RMW write command.

The error correction decoder 240 may perform an error correction decoding operation for the target data based on an error correction code. The error correction decoder 240 may detect an error bit in the target data by performing the error correction decoding operation. When no error bit is detected, the error correction decoder may notify the history buffer manager 230 that the error correction decoding operation is completed. The history buffer manager 230 may change the value of the decoding bit from the first value to the second value in response to completion of the error correction decoding operation. In response to completion of the error correction decoding operation and no error bit being detected as the result of the error correction decoding operation, the history buffer manager 230 may delete the data packet corresponding to the RMW write command from the history buffer 220.

In an embodiment of the present disclosure, the error correction decoder 240 may transmit an error detection signal to the history buffer manager 230 only when an error bit is detected in the target data. When the history buffer manager 230 does not receive any error detection signal from the error correction decoder 240 within a preset maximum error correction time, the history buffer manager 230 may maintain the value of the decoding bit to the second value. The history buffer manager 230 may delete the data packet corresponding to the RMW write command from the history buffer 220 in response to no error detection signal being received from the error correction decoder 240 within the preset maximum error correction time.

In an embodiment of the present disclosure, the operation of generating first modified data based on the target data may be performed before the error correction decoding operation for the target data is completed. According to the present disclosure, the RMW write operation may be completed faster than performing the RMW write operation after the error correction decoding operation for the target data is performed.

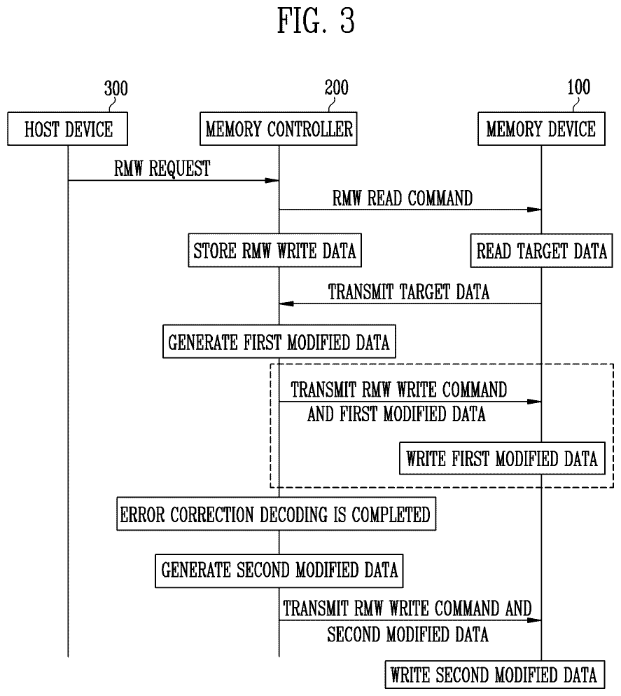

FIG. 3 is a diagram illustrating an RMW operation for rewriting modified data when an error bit is detected in target data according to an embodiment of the present disclosure.

In FIG. 3, an error correction decoder 240 detects an error bit in target data. In the description of FIG. 3, duplication of descriptions corresponding to descriptions of FIG. 2 may be omitted.

A history buffer manager 230 generates first modified data before an error correction decoding operation for the target data is completed, and the command manager 210 transfers the RMW write command and the first modified data to the memory device 100. In response to detection of an error bit in the target data, the error correction decoder 240 may generate corrected target data and transfer the corrected target data to the history buffer manager 230.

The result of the error correction decoding operation for the target data may be stored in a history buffer 220 through a ready bit and a decoding bit. When the error correction decoding operation is completed, the value of the decoding bit is changed from a first value to a second value. When no error bit is detected in the target data, the value of the ready bit is maintained, whereas when an error bit is detected in the target data, the value of the ready bit is changed from the first value to the second value.

The history buffer manager 230 may generate second modified data based on the corrected target data and the RMW write data. Similarly to the first modified data, the history buffer manager 230 may determine the portion to be modified in the corrected target data using a data mask. The history buffer manager 230 may generate the second modified data by applying the RMW write data to the portion in the corrected target data to be modified.

A command manager 210 may transmit the second modified data and the RMW write command to the memory device 100. The memory device 100 may perform an operation of storing the second modified data based on the RMW write command.

Although not illustrated in FIG. 3, after the second modified data is transmitted to the memory device 100, the data packet corresponding to the RMW write command may be deleted from the history buffer 220.

Comparing FIG. 2 and FIG. 3, when an error bit is detected in the target data, modified data is generated twice and the RMW write operation is performed twice. In FIG. 3, performance is lower compared to when, after the error correction decoding operation for the target data is performed, modified data is generated once and then the RMW write operation is performed. However, in an RMW operation, FIG. 2 occurs more frequently than FIG. 3, thus performing an RMW operation according to the present disclosure may improve the operation performance of the storage device.

In an embodiment of the present disclosure, it may be assumed that a storage device 10 is a CXL storage device and that a memory controller 200 is a CXL controller. In order to improve the data throughput of the storage device 10, the size of a data chunk may be increased. In response to the increase in the size of the data chunk, the CXL controller may perform a partial write operation. The partial write operation of the CXL controller may be performed through an RMW operation.

Because the data throughput of a CXL storage device increases, the amount of transferred data addresses also increases. The CXL controller may perform a patrol scrub operation for a CXL storage device using an RMW operation. As the amount of data addresses increases, the number of patrol scrub operations performed by the CXL controller increases. According to an embodiment of the present disclosure, when the patrol scrub operation is performed through the RMW operation in which an error correction operation is skipped, the time taken for the patrol scrub operation may be reduced in proportion to the number of RMW operations that are performed as the patrol scrub operation during unit time of the patrol scrub operation.

Because a partial write operation performed in a CXL storage device is performed through the RMW operation, the time taken for the partial write operation may be reduced in proportion to the number of RMW operations performed during the partial write operation time. Because the probability of error per bit in a DRAM included in a storage device 10 is very low (the error probability may be 10⁻⁶), the total operation time may be reduced through the present disclosure, which is configured to perform an RMW operation in which the error correction operation is skipped.

In an embodiment of the present disclosure, before the first modified data is transmitted to the memory device 100, the error correction decoder 240 may detect an error bit in the target data. The memory controller 200 skips transmission of the first modified data, and the history buffer manager 230 may generate second modified data based on the corrected target data received from the error correction decoder 240. The history buffer manager 230 may change the first modified data to the second modified data. The order in which the second modified data is transmitted to the memory device 100 is determined by the priority at the time at which the second modified data is generated, rather than the priority at the time at which the first modified data is generated.

The history buffer manager 230 may change the ready bit to the first value in response to the error bit that is detected in the target data before transmission of the first modified data to the memory device 100. The history buffer manager 230 may change the ready bit to the second value in response to transmission of the second modified data and the RMW write command to the memory device 100 and may delete the data packet corresponding to the RMW write command from the history buffer 220.

The memory device 100 does not store the first modified data because it does not receive the first modified data. In FIG. 3, the operation that is skipped when an error bit is detected in the target data before transmission of the first modified data to the memory device 100 is marked in the block with the dashed lines.

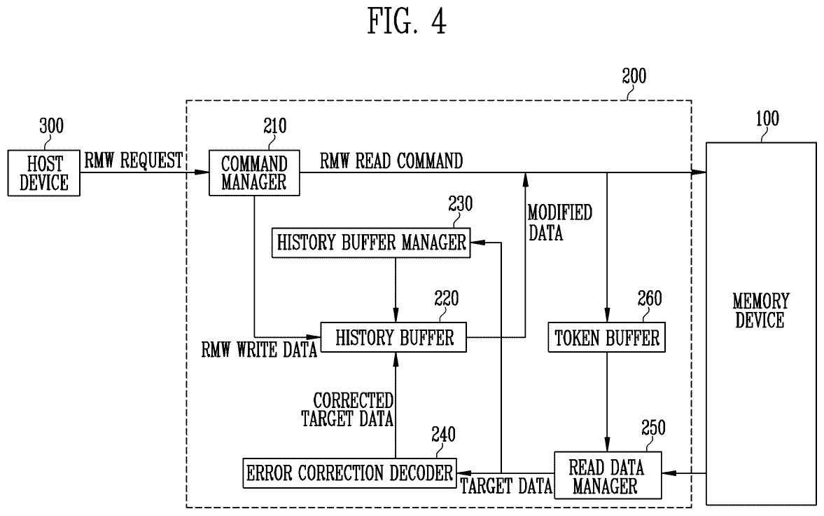

FIG. 4 is a diagram illustrating commands and data that are transferred when an RMW operation is performed according to an embodiment of the present disclosure.

Referring to FIG. 4, a memory controller 200 may receive an RMW request from a host device 300 and receive target data read from a memory device 100. The memory controller 200 may generate first modified data corresponding to RMW write data before performing an error correction decoding operation for the target data, and may transmit an RMW write command and the first modified data to the memory device 100.

The host device 300 may transfer a RMW request to a command manager 210. The RMW request may include an RMW read command, the RMW write command, an RMW flag, the RMW write data, and a data mask. The RMW flag is information indicating that the commands received from the host device 300 are RMW commands.

The command manager 210 determines whether the received read command is an RMW read command, whereupon it does not transmit the read data to the host device 300, based on the RMW flag. When the RMW flag indicates an RMW read command, the command manager 210 transmits the RMW read command to the memory device 100 and stores the RMW write data corresponding to the RMW write command, the data mask, and the like, in a history buffer 220.

The history buffer 220 may store data packets corresponding to write commands. After hazard checks, such as Deep Packet Inspection, for the data packets stored in the history buffer 220, write data may be transmitted to the memory device 100 along with the write command. The history buffer 220 may store RMW write data corresponding to RMW write commands and normal write data corresponding to normal write commands.

The command manager 210 may generate token data in response to transmission of the RMW read command. The token data may include a write pointer pointing to the location at which the RMW write data corresponding to the RMW read command is stored in the history buffer 220 and the RMW flag. A token buffer 260 may store the token data. In an embodiment of the present disclosure, the history buffer 220 and the token buffer 260 may be different buffer memories.

A read data manager 250 may receive the target data from the memory device 100. The read data manager 250 may add the corresponding token data to the target data. The read data manager 250 may determine whether the read data received from the memory device 100 is the target data based on the token data. The read data manager 250 may transfer the target data to each of a history buffer manager 230 and an error correction decoder 240.

The history buffer manager 230 may match the RMW write data with the target data based on the token data added to the target data. The write pointer of the target data is the same as the write pointer of the RMW write data. The history buffer manager 230 may determine the portion to modify in the target data using the data mask. The data mask may be a byte mask. The history buffer manager 230 may generate first modified data by applying the RMW write data to the target data.

The history buffer manager 230 may generate a ready bit in response to generation of the first modified data. When the value of the ready bit is changed from a first value to a second value, the command manager 210 may transmit the first modified data to the memory device 100 along with the RMW write command. The history buffer manager 230 may change the value of the ready bit from the second value to the first value in response to transmission of the first modified data.

The error correction decoder 240 may perform an error correction decoding operation for the target data. The error correction decoder 240 may detect an error bit in the target data. The error correction decoder 240 may generate corrected target data in response to detection of an error bit and transfer the corrected target data to the history buffer manager 230.

The history buffer manager 230 may set the value of a decoding bit, indicating whether the error correction decoding operation is completed, to the first value in response to generation of the first modified data. The error correction decoder 240 transfers the result of the error correction decoding operation for the target data to the history buffer manager 230, and the history buffer manager 230 may set the value of the decoding bit to the second value. The history buffer 220 may add the ready bit and the decoding bit to the data packet corresponding to the RMW write command and store the data packet.

The history buffer manager 230 may generate second modified data in response to reception of the corrected target data. Similarly to the first modified data, the second modified data may be generated using the corrected target data, the RMW write data, and the data mask. The command manager 210 may transmit the second modified data and the RMW write command to the memory device 100.

Depending on the result of the error correction decoding operation, the values of the ready bit and the decoding bit may be changed. For example, when an error bit is detected in the target data, the ready bit may be set to a second value even if the first modified data is already transferred to the memory device 100 or even before the second modified data is generated. When the value of the decoding bit is the second value, the history buffer manager 230 may change the value of the ready bit to the first value only after the second modified data and the RMW write command are transferred to the memory device 100.

The history buffer manager 230 may delete the data packet corresponding to the RMW write command for which the first modified data or the second modified data is transmitted to the memory device and for which the error correction decoding operation is completed. Even after the first modified data is transmitted, the history buffer manager 230 retains the data packet corresponding to the RMW write command in the history buffer 220 until the error correction decoding operation for the target data is completed. When no error bit is detected in the target data, the history buffer manager 230 may delete the data packet corresponding to the RMW write command from the history buffer 220.

When an error bit is detected in the target data, it is necessary to generate second modified data, so the data packet corresponding to the RMW write command is retained in the history buffer 220 until the second modified data and the RMW write command are retransmitted to the memory device 100. When the second modified data and the RMW write command are transmitted to the memory device 100, the history buffer manager 230 may delete the data packet corresponding to the RMW write command from the history buffer 220.

In an embodiment of the present disclosure, the command manager 210 may include a schedule table that specifies the transmission priority of data and commands to be transmitted to the memory device. The transmission priority of the first modified data and the RMW write command is determined according to the order in which the first modified data and the RMW write command are transferred to the command manager 210. Even after the first modified data and the RMW write command are transferred to the command manager 210, transfer of the first modified data and the RMW write command to the memory device 100 may be delayed depending on transmission priority. If the first modified data and the RMW write command are transferred to the command manager 210 but not yet transferred to the memory device 100, even though the second modified data is generated due to detection of an error bit, the second modified data and the RMW write command may not be transferred to the command manager 210 in order to prevent data hazards. The second modified data and the RMW write command are transferred to the command manager 210 after the first modified data and the RMW write command are transferred to the memory device 100.

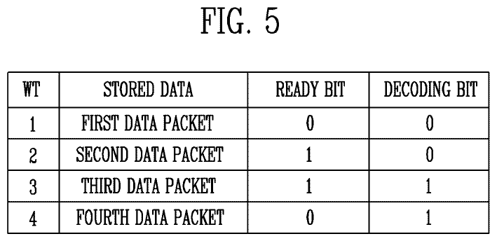

FIG. 5 is a diagram illustrating data packets stored in a history buffer according to an embodiment of the present disclosure.

Referring to FIG. 5, data packets stored in a history buffer 220 are illustrated. Each of the data packets may include RMW write data corresponding to an RMW write command, a data mask, an RMW flag, and the like. A write pointer (WT) for identifying each data packet in the history buffer 220 may be assigned. A ready bit and a decoding bit may be added to each of the data packets stored in the history buffer 220.

In FIG. 5, a first data packet is a data packet corresponding to a first RMW write command. The write pointer of the first data packet is 1, and both the ready bit and the decoding bit of the first data packet are 0. The first data packet may represent an initial state of a data packet corresponding to an RMW write command stored in the history buffer. The RMW read command corresponding to the RMW write command has been transmitted or is scheduled to be transmitted to a memory device 100, and the target data corresponds to the RMW read command has not been received by the memory controller 200. Because first modified data is not yet generated based on the target data and the RMW write data, the value of the ready bit is maintained at 0. Because the target data is not yet received by a memory controller 200, a decoding operation is not yet performed, so the decoding bit is also maintained at 0. In an embodiment of the present disclosure, 0 may be a first value. In an embodiment of the present disclosure, the decoding bit is enabled in response to generation of the first modified data, and when the decoding bit is enabled, the bit value may be set depending on whether the decoding operation is completed. The decoding bit may not be enabled before the first modified data is generated.

The second data packet is a data packet corresponding to a second RMW write command. A write pointer of the second data packet is 2, a value of the ready bit of the second data packet is 1, and a value of the decoding bit is 0. In an embodiment of the present disclosure, 1 may be a second value. The second data packet corresponds to a state in which the first modified data is generated because the target data corresponding to RMW read command is received by the memory controller 200. In response to generation of the first modified data, the value of the ready bit is changed from 0 to 1. Because an error correction decoding operation for the target data is not yet completed, the value of the decoding bit is maintained at 0. Because the value of the ready bit is 1, the first modified data and the RMW write command may be transmitted to the memory device 100. In response to transmission of the first modified data and the RMW write data, the value of the ready bit may be changed from 1 to 0.

A third data packet is a data packet corresponding to a third RMW write command. A write pointer of the third data packet is 3, and the values of the ready bit and decoding bit of the third data packet are 1. The third data packet may correspond to the state in which an error correction decoding operation for the target data is completed. When the error correction decoding operation is completed, the value of the decoding bit is 1. Alternatively, the third data packet may be a data packet corresponding to a normal write command, rather than an RMW write command.

The value of the ready bit may vary depending on the result of the error correction decoding operation and whether the first modified data is transmitted. When transmission of the first modified data is not yet completed, the value of the ready bit is maintained at 1. Even though the value of the ready bit is changed to 0 because transmission of the first modified data is completed, the value of the ready bit may be changed to 1 if an error bit is detected in the target data. The history buffer manager 230 may maintain the value of the ready bit at 1 until corrected target data is transferred and second modified data is generated. That is, when the value of the decoding bit is 1, the value of the ready bit is maintained at 1 until the second modified data is generated, regardless of whether the first modified data is transmitted, and the value of the ready bit is changed to 0 in response to transmission of the second modified data.

A fourth data packet is a data packet corresponding to a fourth RMW write command. A write pointer of the fourth data packet is 4, the value of the ready bit of the fourth data packet is 0, and the value of the decoding bit thereof is 1. The fourth data packet corresponds to a state in which no error bit is detected in the target data and the first modified data and the RMW write command are transmitted to the memory device 100. The fourth data packet may be deleted from the history buffer 220.

The history buffer 220 illustrated in FIG. 5 is merely an example, and the data packets, decoding bits, and ready bits stored in the history buffer may vary.

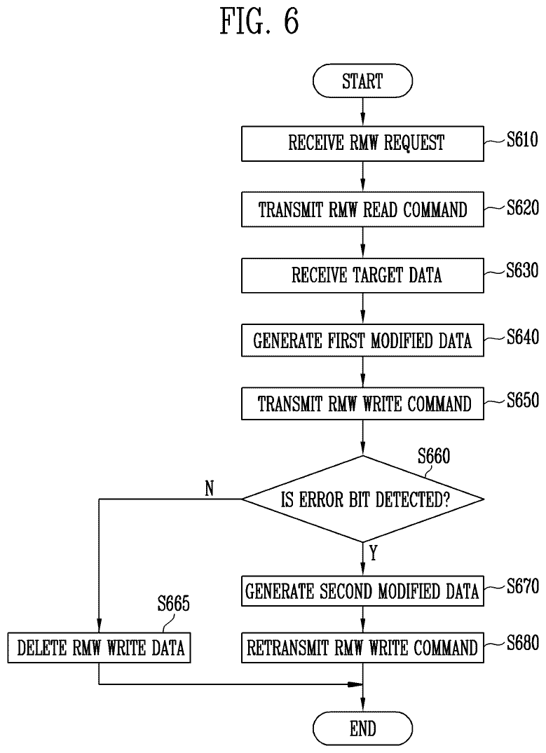

FIG. 6 is a flowchart illustrating a method of performing an RMW operation according to an embodiment of the present disclosure.

Referring to FIG. 6, in response to an RMW request received from a host device, a memory controller may generate first modified data based on target data and RMW write data before an error correction decoding operation for the target data corresponding to an RMW read command is completed. The memory controller transmits the first modified data and an RMW write command to a memory device, and the memory device may perform an RMW write operation. When no error bit is detected in the target data, the memory controller may delete the RMW write data from a history buffer. When an error bit is detected in the target data, the memory controller may generate second modified data based on corrected target data.

At step S610, a command manager may receive an RMW request to perform read, modify, and rewrite operations on target data stored in the memory device from the host device. The command manager may determine whether the received request is an RMW request based on the RMW flag included in the RMW request. A history buffer may store the RMW write data corresponding to an RMW write command.

At step S620, the command manager may transmit the RMW read command included in the RMW request to the memory device. The command manager may generate token data in response to transmission of the RMW read command.

At step S630, a read data manager may receive the target data corresponding to the RMW read command. The read data manager may add the token data corresponding to the RMW read command to the target data. The read data manager may transfer the target data to a history buffer manager and an error correction decoder.

At step S640, the history buffer manager may generate first modified data based on the RMW write data and the target data before an error correction decoding operation is performed for the target data. The history buffer manager may generate a ready bit indicating whether the first modified data is generated.

At step S650, the command manager may transmit the first modified data and the RMW write command to the memory device. The memory device may perform an RMW write operation by receiving the first modified data and the RMW write command.

At step S660, the error correction decoder may detect an error bit in the target data. The command manager may determine whether to retransmit the RMW write command based on the result of the error correction decoding operation. The error correction decoder may generate a decoding bit indicating whether the error correction decoding operation is performed.

When no error bit is detected in the target data, the process proceeds to step S665, and when an error bit is detected in the target data, the process may proceed instead to step S670. The error correction decoder may represent the result of the error correction decoding operation using the ready bit and the decoding bit stored in the history buffer.

At step S665, the history buffer manager may delete the RMW write data from the history buffer. When no error bit is detected in the target data, the processing speed of the RMW operation may be improved.

At step S670, the error correction decoder may generate corrected target data corresponding to the target data based on an error correction code. The history buffer manager may generate second modified data based on the corrected target data and the RMW write data.

At step S680, the command manager may receive the second modified data and transmit the second modified data and the RMW write command to the memory device. The memory device may receive the second modified data and the RMW write command and again perform the RMW write operation.

According to the present disclosure, a storage device configured to perform a read-modify-write operation by skipping an error correction decoding operation for read data not being provided to a host device and a method of performing a read-modify-write operation may be provided.

The scope of the present disclosure is defined by the accompanying claims, rather than by the detailed description, and all modifications or changes derived from the meaning and scope of the claims and equivalents thereof should be construed as falling within the scope of the present disclosure.

What is claimed is:

1. A memory controller, comprising:
a command manager configured to receive a read-modify-write (RMW) request, from a host device, to perform read, modify, and write operations on target data stored in a memory device and configured to transmit an RMW read command and an RMW write command included in the RMW request to the memory device;
a history buffer configured to store RMW write data corresponding to the RMW write command;
a history buffer manager configured to generate first modified data corresponding to the target data based on the RMW write data;
an error correction decoder configured to perform an error correction decoding operation for the target data received from the memory device based on an error correction code; and
a read data manager configured to receive the target data corresponding to the RMW read command from the memory device and to transfer the target data to the history buffer and the error correction decoder,
wherein the history buffer manager generates the first modified data before the error correction decoding operation is performed for the target data.

2. The memory controller according to claim 1, wherein:
the history buffer stores a ready bit indicating whether the first modified data is generated, a decoding bit indicating whether the error correction decoding operation is performed, and
the RMW write data to which the ready bit and the decoding bit are added.

3. The memory controller according to claim 2, wherein the command manager transmits the RMW write command and the first modified data to the memory device based on the ready bit.

4. The memory controller according to claim 2, wherein the history buffer manager sets a value of the ready bit to a first value in response to transmission of the RMW read command, and changes the value of the ready bit from the first value to a second value in response to generation of the first modified data and changes the value of the ready bit from the second value to the first value in response to transmission of the first modified data and the RMW write command.

5. The memory controller according to claim 2, wherein the history buffer manager sets a value of the decoding bit to a first value in response to generation of the first modified data and changes the value of the decoding bit from the first value to a second value in response to completion of the error correction decoding operation.

6. The memory controller according to claim 5, wherein the history buffer manager maintains the value of the decoding bit from the first value to the second value in response to no error detection signal being received from the error correction decoder within a preset correction time.

7. The memory controller according to claim 4, wherein the history buffer manager sets the value of the ready bit to the second value in response to detection of an error bit in the target data.

8. The memory controller according to claim 7, wherein the error correction decoder generates corrected target data in response to detection of the error bit in the target data and transfers the corrected target data to the history buffer manager.

9. The memory controller according to claim 8, wherein the history buffer manager generates second modified data based on the corrected target data and the RMW write data.

10. The memory controller according to claim 9, wherein the command manager transmits the RMW write command and the second modified data to the memory device and changes the value of the ready bit from the second value to the first value.

11. The memory controller according to claim 10, wherein the history buffer manager deletes the RMW write data stored in the history buffer in response to the ready bit set to the first value and the decoding bit set to the second value.

12. A method of operating a memory controller, comprising:
receiving a read-modify-write (RMW) request, from a host, to perform read, modify, and write operations on target data stored in a memory device;
transmitting an RMW read command included in the RMW request to the memory device;
receiving the target data corresponding to the RMW read command from the memory device;
generating first modified data based on the target data and RMW write data corresponding to an RMW write command included in the RMW request before performing an error correction decoding operation for the target data; and
transmitting the RMW write command and the first modified data to the memory device.

13. The method according to claim 12, further comprising:
performing the error correction decoding operation for the target data; and
determining whether to retransmit the RMW write command based on a result of the error correction decoding operation.

14. The method according to claim 13, wherein:
receiving the RMW request comprises storing the RMW write data in a history buffer,
generating the first modified data comprises generating a ready bit indicating whether the first modified data is generated,
performing the error correction decoding operation comprises, in response to generation of the first modified data, generating a decoding bit indicating whether the error correction decoding operation is performed, and
the history buffer stores the RMW write data to which the ready bit and the decoding bit are added.

15. The method according to claim 14, wherein:
performing the error correction decoding operation further comprises generating corrected target data in response to detection of an error bit in the target data, and
determining whether to retransmit the RMW write command further comprises:
generating second modified data based on the corrected target data and the RMW write data,
transmitting the RMW write command and the second modified data to the memory device, and
deleting the RMW write data from the history buffer.

16. The method according to claim 14, wherein determining whether to retransmit the RMW write command comprises deleting the RMW write data from the history buffer in response to no error bit being detected in the target data.

17. A storage device, comprising:
a memory device configured to store data; and
a memory controller configured to control operations of the memory device,
wherein the memory controller comprises:
a command manager configured to receive a read-modify-write (RMW) request, from a host, to perform read, modify, and write operations on target data stored in the memory device and configured to transmit an RMW read command included in the RMW request to the memory device,
a history buffer configured to store RMW write data corresponding to an RMW write command included in the RMW request, and
a history buffer manager configured to generate first modified data corresponding to the RMW write command based on the RMW write data and the target data, and
wherein the command manager transmits the RMW write command and the first modified data to the memory device without performing an error correction decoding operation for the target data.

18. The storage device according to claim 17, wherein:
the history buffer stores a ready bit indicating generation of the first modified data, a decoding bit indicating whether the error correction decoding operation is performed for the target data, and the RMW write data to which the ready bit and the decoding bit are added.

19. The storage device according to claim 17, wherein:
the memory controller further comprises an error correction decoder configured to perform the error correction decoding operation for the target data based on an error correction code and to generate corrected target data in response to detection of an error bit in the target data,
the history buffer manager generates second modified data based on the RMW write data and the corrected target data, and
the command manager transmits the second modified data and the RMW write command to the memory device.

20. The storage device according to claim 19, wherein the history buffer manager deletes the RMW write data from the history buffer in response to the corrected target data not being generated and transmission of the first modified data to the memory device.

21. The storage device according to claim 19, wherein the history buffer manager deletes the RMW write data from the history buffer in response to generation of the corrected target data and transmission of the second modified data to the memory device.
